(19) United States
(12) Patent Application Publication
(10) Pub. No.: US 2007/0288559 A1
(43) Pub. Date: Dec. 13, 2007

(54) Matching Website with Context Sensitive Profiling

(76) Inventor: Walter Parsadayan, Laguna Niguel, CA (US)

Correspondence Address: Rutan & Tucker, LLP.;Hani Z. Sayed, 611 ANTON BLVD, SUITE 1400, COSTA MESA, CA, 92626, US

(21) Appl. No.: 11/422,934

(22) Filed: Jun. 8, 2006

(51) Int. Cl. G06F 15/16

(52) U.S. Cl. 709/204

(57) ABSTRACT

An online matching service provides a personal profile of at least one subscriber, wherein the personal profile is preferably automatically updated using information that is extracted from electronic communication between the subscriber and another person using the service. While in some aspects a person reviews the electronic communication to update the personal profile, other embodiments employ context sensitive text analysis algorithms.

### FIELD OF THE INVENTION

The field of the invention is configuration and methods for online matching services, and especially for services that provide a subscriber profile.

### BACKGROUND OF THE INVENTION

There are numerous online matching services known in the art, and such services may be categorized in various manners, including free services and subscription-based services, services with video capability or text only capability, availability of direct chat, email, or other form of communication, etc. However, regardless of the particular type, all or almost all of such services rely in one form or another on a personal subscriber profile that helps a person that is interested in initiating a contact with the subscriber to narrow down a likely matching candidate from the entire database content of subscribers (see e.g., WO 2006/033800 or U.S. Pat. App. No. 2005/0288944).

As personal profiles are generally structured and provide a readily accessible and often preformatted pool of information, many online matching services employ these profiles as tool in establishing a ranking, compatibility index, or to prescreen for potential matches within the database or against a profile obtained by a user. While structured profiles are often advantageous in automated processes, they are typically less than satisfactory in providing an accurate reflection of a subscriber's true personality. To that end, the subscriber has to elaborate on his or her profile with each of the contacts he or she establishes communication. Alternatively, the subscriber can edit his or her profile. However, such editing is necessarily exposed to the same weaknesses as the originally created profile.

Remarkably, only very few instances are reported in which a personal profile is fine-tuned for specific purposes. For example, as described in WO 2005/022419, a matching service provides a first set of predetermined questions, to which the subscriber answers. Depending on the particular answers, the matching service will then present a second set of predetermined questions which are then employed to develop an honesty and/or more detailed personality profile. While such an approach may indeed provide a more accurate personal profile, various disadvantages remain. Among other things, all first and second questions are predetermined and therefore limited in their capability to explore alternative areas. Moreover, all answer by the user are ranked using a numerical system, which will ultimately reduce total personal information to a numeric score.

Therefore, while numerous online matching services and methods are known in the art, all or almost all of them suffer from one or more disadvantages. Thus, there is still a need to provide an improved online matching system.

### SUMMARY OF THE INVENTION

The present invention is directed to configurations and methods for operation of online matching services in which a subscriber has a personal profile, and in which the profile is preferably automatically modified using information extracted from electronic communications between the subscriber and other parties using the matching service.

In one aspect of the inventive subject matter, a method of providing an online matching service includes a step of allowing a first user to post a first personal profile. In another step, a second user is allowed to view at least part of the first personal profile and the second user is permitted to electronically communicate with the first user. In yet another step, the electronic communication between the first and second user is analyzed to extract information about the first user, and in still another step, the first personal profile is updated to a second personal profile.

Most typically, the first and second users communicate via online chat, email, telephone, and/or video conference, and the step of analyzing includes transfer of at least a portion of the electronic communication as an electronic copy or transcript to a third party that reviews the electronic communication (e.g., for personal information not contained in the first personal profile). In such configurations and methods, the third party will modify the personal profile of the first person, optionally in real-time (e.g., where the communication is a video conference).

Alternatively, or additionally, the electronic communication may also be automatically monitored. For example, in such configurations and methods, a context sensitive algorithm may extract personal information using results from a keyword search, which may or may not be performed independently. Where desired, the extracted information is compared with personal information already contained in the first personal profile and used to supplement already present information and/or add new information not already contained in the personal profile. As with already known online matching services, the first and/or second user may be required to pay a fee to the service to view the personal profile. Furthermore, ad where desired, it is contemplated that the second personal profile is forwarded to the first user for authorization and/or editing, and that the first personal profile is replaced with the second personal profile such that the second user and/or a third user can view the second personal profile.

In another aspect of the inventive subject matter, a method of modifying or updating a personal profile in an online matching service includes a step of allowing a first user and a second user to electronically communicate via a remote computer (relative to the first and second users) wherein at least one of the first and the second user has a personal profile. In another step, the electronic communication between the first and second user is analyzed to extract information about the first and/or second user, and in still another step, the personal profile(s) is modified using the extracted information. Similar to the configurations and methods contemplated above, it is preferred that the electronic communication an online chat, email, telephone, and/or a video conference. The step of analyzing may either include transfer of at least a portion of the electronic communication as an electronic copy or transcript to a third party that reviews the electronic communication and/or an automated keyword search performed by a context sensitive algorithm that extracts personal information using a result from the keyword search. Regardless of the manner of extraction, it is generally preferred that the step of modifying is performed by an algorithm that adds the extracted information to the at least one personal profile.

Various objects, features, aspects and advantages of the present invention will become more apparent from the following detailed description of preferred embodiments of the invention.

### DETAILED DESCRIPTION

The inventor has discovered that matching services, and especially online matching services can be significantly improved using configurations and methods that allow to update a subscriber specific personal profile without direct intervention of the subscriber. Most typically, the profile will be continuously updated using personal information relayed from the subscriber to a suitor or other person interested in establishing a personal contact with the subscriber. Among other advantages, it should be appreciated that the subscriber's personal profile will not only increase in accuracy over time, but will also proportionally reflect the subscriber's personal interests. Most commonly, contemplated matching services will assist the subscriber and/or another user of the service to find a compatible person with which to communicate, and in at least some cases also to begin a personal relationship (which may lead to a dating or even family relationship). Contemplated matching services may also be useful in personal coaching in which the subscriber and his or her coach are in electronic communication. Here, and among other options, the personal profile may be periodically saved and used as a diary to monitor progress or other change in behavior or attitude.

In one exemplary aspect of the inventive subject matter, an online matching service operates a website that is publicly available from a network of computers, most typically via the Internet. The website is preferably programmed to provide a user interface through which a subscriber can enter a personal profile and other information (e.g., email address, chat alias, picture, etc.), wherein the profile and/or additional information is stored in a database that is informationally coupled to the website. The user interface will further preferably be programmed to allow access to at least some of the data contained in the database to thereby allow viewing of the profile by a user other than the subscriber. Most typically, the website will also include secure features for data entry and/or retrieval and payment processing.

In one especially preferred aspect of the inventive subject matter, it is contemplated that the website will directly or indirectly provide one or more channels of communication between the subscriber and another user of the service (typically a suitor or other person interested in communicating with the subscriber), wherein at least one of the channels are typically made available through and/or on the same computer on which the website and/or database is hosted. Especially preferred communication channels include a chat room, email accounts, telephone (e.g., voice-over-IP channels), videoconferences, etc. Depending on the particular website ands/or communication channel, it should be noted that the electronic communication may be in real-tome, or be performed in a sequential manner in which the subscriber submits a question or answer that may be directly or indirectly be answered in a subsequent electronic communication.

In another preferred aspect of the inventive subject matter, communication in at least one of the communication channels between the subscriber and the other user is monitored and/or analyzed by a third party (human and/or computer algorithm), wherein personal information is extracted by the third party from information exchanged between the subscriber and the other user. For example, where the communication is a written exchange in a chat room or email, the information may be directly extracted using a keyword search. Additionally or alternatively, where the communication has a voice component, voice recognition can be applied to the voice communication and used to translate the voice communication into a text file. The keywords may then be used for context analysis and/or search for further other keywords in proximity using text and/or grammar analytical processes well known in the art. For example, a sentence or paragraph that includes the keyword “travel” may be parsed to find context associated qualifiers such as “like to”, “love to”, “foreign”, “Paris” etc., to identify a personal preference or aversion for travel or a specific travel location. Such extracted information can then be added to an already existing personal profile, or may even be used to establish a first personal profile. Of course, it should be recognized that the keyword analysis may be performed in a fully automated manner using text analytical software or may be assisted by a simple keyword search tool that highlights the keywords for a human operator. In a technically least complex aspect, a recording, copy, and/or transcript may also be provided to the third party for semi-automated or even completely manual analysis. The so extracted personal information may then be added manually or in an automated fashion to a database to update an existing personal profile or to establish a personal profile.

Therefore, the inventor especially contemplates a method of providing an online matching service in which a first user (typically the subscriber or a representative of the subscriber) posts a first personal profile, wherein the posting typically employs one or more fillable forms or text boxes in a website, drop-down selections, radio buttons, etc. However, all other known manners of data entry, including posting of attachments, sound, and/or image data are also deemed suitable. In contemplated methods, a second user (typically a suitor or other person interested in establishing communication with the first user) will be allowed, optionally for a fee, to view at least part of the first personal profile. Alternatively, or additionally, the first user may also be required to pay a fee. In a further aspect of contemplated methods, the second user is then permitted to electronically communicate with the first user. Most typically, a communication channel (e.g., email address and email server, chat room, etc.) is provided by the online matching service in a manner such that the online matching service has direct or indirect access to at least part of the communication between the first and second user. For example, the online service may copy all written communication to a separate file, or operate speech recognition software that extracts a text file from a verbal communication. In another example, an email provider may forward a copy of an email exchange to the online matching service. In a still further step of contemplated methods, the communication between the first and second user is analyzed (e.g., using a human or software) and information about the first user is extracted, which is then used to update the first personal profile to a second personal profile. Of course, where no personal profile was initially established, it should be noted that that the information may also be employed to generate a first personal profile.

It should be noted that contemplated online matching services may operate in a manner substantially similar to those already known in the art, using one or more graphic user interfaces that allow for convenient data entry and retrieval. Similarly, informational coupling of the electronic communication channels with the online matching service may be performed using methods and devices well known in the art. For example, contemplated online matching websites may include one or more chat rooms, provide a text and/or email exchange service, or may allow for audio (e.g., telephone or otherwise) and/or videoconferences. Where it is preferred that the online matching service has an income stream in addition to or besides commercial advertising, it is contemplated that at least one of the first and second users will be required to pay a fee prior to viewing the personal profile.

With respect to the step of analyzing the electronic communication between the first and second user, it is generally contemplated that at least a portion of the electronic communication is transferred or copied (e.g., as an electronic copy or transcript) to a person that reviews the electronic communication. Such review may be performed in real time as the first and second users communicate, or in a delayed manner. For example, electronic copies or transcripts may be transmitted to a person in a location other than the location of the online matching service, and even abroad. Wile not limiting to the inventive subject matter, it is typically preferred that the person reviews the electronic communication for personal information that is not contained in the first (or current) personal profile. The person will then update the first or current personal profile to the second personal profile using the differential personal information content. In another example, it is contemplated that the step of analyzing comprises a real-time review of the electronic communication by the person, which may be particularly advantageous where the electronic communication is an audio or videoconference. Analysis of personal information may be performed using numerous manners, however, it is generally preferred that the electronic communication is reviewed for the presence of a keyword search indicative of a personal trait. The keyword search is typically performed by software, which may be programmed to comprise context sensitive algorithm that extracts personal information using a result from the keyword search. In such case, the person would have predominantly an editorial function rather than a search function.

Alternatively, or additionally, it should be appreciated that the analysis of the electronic communication may also be performed in an automated manner using context sensitive text analysis algorithms well known in the art. For example, and among other suitable choices, the electronic communication may be analyzed using devices and methods as described in U.S. Pat. Nos. 6,839,665, 6,665,661, 5,819,260, 5,297,039, and 5,164,899 (all of which are incorporated by reference herein). It is still further contemplated that additional information may be employed to extract personal information and suitable additional information includes of cookies and other tracking information on the users computer.

Alternatively, or additionally, information may also be extracted from the communication using a keyword filter (operated by a human or using software algorithm), wherein presence of a key word or keyword combination will be linked to one or more questions related to the keyword or keyword combination. For example, where the keywords “dog” and “like” or “love” are in close proximity (e.g., within 1-6 words), a human analyst or software may provide the questions “What kind of dogs do you prefer?” or “Do you like other pets?” to the subscriber and/or other user. The answer(s) to such questions can then be entered into the personal profile in a manual and/or automated manner. Most typically, the keyword search will be limited to keywords used by the subscriber in an exchange other than a question. However, it should be noted that the keyword search for generation of a question may also be performed in questions of the subscriber to the other user, and even in questions and/or answers of the other user.

It should be appreciated that in such operations the questions may be preformatted questions from an expected set of keywords common in human personal communications, automatically generated using context and syntax driven algorithms, and/or questions that are formulated by a human. Thus, in such aspects of the inventive subject matter, it should be appreciated that the personal profile updating is driven by the context of the communication between the subscriber and another user of the service.

Regardless of the manner of analyzing it is preferred that the extracted information is compared with personal information already contained in the first personal profile. Comparison may provide not only validation of extracted information against already entered data, but also provide an indication of a person's consistency and/or honesty, which may be made available to the first and/or second user. Most typically, extracted information is only added to the first or current personal profile that is not already contained therein. Thus, suitable added information includes information that is supplemental or complementing to personal information contained in the first or current personal profile, and/or entirely new information relative to the first or current personal profile. Where desired, it is contemplated that the second personal profile is forwarded to the first user for authorization and/or editing. The first or current personal profile is then replaced or updated to the second personal profile such that the second and optionally further user can view the second personal profile.

Where the matching service also includes generation of questions based on keywords in the electronic communication, it is contemplated that that the questions may not only be asked to update or complete the personal profile (in a manual and/or automated fashion), but also to validate earlier provided information by the subscriber. Thus, in especially contemplated aspects of the inventive subject matter, the questions may be based on a comparison of a current electronic communication and the present personal profile and/or based on a comparison of the current electronic communication and a previous electronic communication. Depending on the particular match or discrepancy, a consistency index may be established which may be provided to the subscriber for review or be employed as part of a lie detector test. Alternatively, or additionally, the information extracted from the electronic communication may also be analyzed for consistency and/or contradictions with the personal profile and/or previous electronic communications. In such case, and especially where a contradiction and/or inconsistency is detected, an email or other message may be sent to the subscriber pointing out the contradiction and/or inconsistency (which may or may not be corrected at that time).

Similarly, and especially where the non-subscriber user can be identified via a cookie or other identification tag, the electronic communication may be monitored to provide the subscriber with a consistency index of that user. For example, the electronic communication of that user may indicate in one session that the user likes dogs and dislikes cats, while the user indicates in another session (typically with another subscriber) that he likes cats and dislikes dogs. Such extracted information is preferably stored on a computer other than the user's computer and may be made available to the subscribers and optionally the user. As above, and where desired, questions may be posed to the user to refine or clarify his or her position relative to a specific keyword. Consequently, contemplated matching services are not only context sensitive and adaptive with regard to a personal profile, but also provide verification and even lie detector functionality. Most typically, such lie detector tests will compare extracted information (via subsequent question and/or monitoring of electronic communication) between the personal profile and an electronic communication and/or between a first and a second electronic communication of the subscriber (and/or of the other user).

In a still further contemplated aspect of the inventive subject matter, it is contemplated that the personal profile (first, or updated) may be matched against other profiles in the database of the online matching service using methods known in the art. For example, matching can be done by ranking keyword occurrence, or by extraction of personal preferences in a manner similar as described above. In yet further aspects of the inventive subject matter, it is also contemplated that a personal profile can be established for the second user. In such methods, the second user will be identified by a cookie, processor serial number, or other unique identifier, which may reside in the hardware and/or software (with respect to the manner of generation of the second user's personal profile, the same considerations as provided above apply). Most typically, but not necessarily, the personal profile of the second user (i.e., the suitor or other person interested in establishing a personal contact with the subscriber) will not be revealed to the second user, but may be made available to the first user. Such system may, among other advantages, encourage the first user to verify and/or compare statements made in the electronic communication between the first and second users. Extraction of the second person's personal profile may also be used to suggest a match of the second person with a first person (e.g., based on similarity of personal profiles), wherein the suggestion may be generated in an automated fashion, or via limited or public availability of the profiles for first and second users. In still further contemplated aspects of the inventive subject matter, the user profile for the first and/or second user may be released (e.g., with consent of user) to one or more commercial entities for further data mining and/or sale to advertising agencies.

Therefore, it should be recognized that contemplated configurations and methods may be implemented in a new online matching service or may advantageously be used as upgrade to an existing online matching service. Thus, and viewed from a different perspective, a method of modifying a personal profile in an online matching service is contemplated in which in one step a first user and a second user are allowed to electronically communicate via a remote computer, wherein at least one of the first and the second user has a personal profile. Most typically, the personal profile is stored at the same computer or computer system on which the database for the subscribers is located. However, in less preferred aspects, the personal profile (optionally along with image and/or video data may be stored at a remote computer (relative to the database location). For example, the personal profile may be stored at the subscriber's computer and be uploaded when needed. In a further step of such methods, the electronic communication between the first and second user is analyzed to extract information about the first and/or the second user in a manner as already described above. In yet another step of contemplated methods, the personal profile of the first and/or second user is modified using the extracted information.

It should be noted that most or even all of the steps in such methods may be performed as described above or modified to accommodate to specific requirements of a database structure where the method is used to upgrade that database structure. Thus, it is generally preferred that the step of analyzing the electronic communication will comprise a step of transferring of at least a portion of the electronic communication as an electronic copy or as a transcript to a person that reviews the electronic communication. The step of analyzing may then comprise an automated keyword search, which may be performed by a person, or which may be performed by a context sensitive algorithm that extracts personal information (e.g., using a result from the keyword search). Similar to contemplated methods above, it is preferred that the step of modifying is also automatically performed by an algorithm that adds the extracted information to the at least one personal profile. Such addition may be in table format, optionally grouped by keywords, or as free form text. Thus, in such and other contemplated methods, it should be appreciated that the first and the second user may have a first and second personal profile, respectively.

Thus, specific embodiments and applications of online matching services with context sensitive profiling have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Furthermore, where a definition or use of a term in a reference, which is incorporated by reference herein is inconsistent or contrary to the definition of that term provided herein, the definition of that term provided herein applies and the definition of that term in the reference does not apply.

What is claimed is:

1. A method of providing an online matching service, comprising:
allowing a first user to post a first personal profile;
allowing a second user to view at least part of the first personal profile and allowing the second user to electronically communicate with the first user;
analyzing the electronic communication between the first and second user to extract information about the first user; and
updating the first personal profile to a second personal profile using the extracted information.

2. The method of claim 1 wherein the second user electronically communicates with the first user by at least one of online chat, email, and telephone, and video conference, and
wherein electronic communication is optionally used in personal coaching.

3. The method of claim 1 wherein the step of analyzing comprises a step of transferring of at least a portion of the electronic communication as an electronic copy or transcript to a person that reviews the electronic communication.

4. The method of claim 3 wherein the person reviews the electronic communication for personal information not contained in the first personal profile and optionally provides a question to the first user.

5. The method of claim 3 wherein the person updates the first personal profile to the second personal profile.

6. The method of claim 1 wherein the step of analyzing comprises real-time review of the electronic communication by a person.

7. The method of claim 1 wherein the electronic communication is at least one of online chat and email, and wherein the step of analyzing comprises a step of keyword search.

8. The method of claim 7 wherein the keyword search is performed by a context sensitive algorithm that extracts personal information using a result from the keyword search and optionally provides a question to the first user.

9. The method of claim 1 wherein the extracted information is compared with personal information already contained in the first personal profile.

10. The method of claim 9 wherein the step of updating comprises adding extracted information to the first personal profile that is not contained in the first personal profile, and wherein the extracted information is optionally obtained from a question asked to the first user.

11. The method of claim 9 wherein the step of updating comprises adding extracted information to the first personal profile that is supplemental to the personal information contained in the first personal profile, and wherein the extracted information is optionally obtained from a question asked to the first user.

12. The method of claim 1 wherein the step of analyzing the electronic communication between the first and second user includes use of the extracted information and optional use of a question in a lie detector test.

13. The method of claim 1 wherein the second personal profile is forwarded to the first user for at least one of authorization and editing.

14. The method of claim 1 wherein the first personal profile is replaced with the second personal profile such that at least one of the second user and a third user can view the second personal profile.

15. A method of modifying a personal profile in an online matching service, comprising:
allowing a first user and a second user to electronically communicate via a remote computer wherein at least one of the first and the second user has a personal profile;
analyzing the electronic communication between the first and second user to extract information about at least one of the first and second user; and
modifying the at least one personal profile using the information.

16. The method of claim 15 wherein the electronic communication is at least one of online chat, email, telephone, and video conference.

17. The method of claim 15 wherein the step of analyzing comprises a step of transferring of at least a portion of the electronic communication as an electronic copy or transcript to a person that reviews the electronic communication.

18. The method of claim 15 wherein the step of analyzing comprises an automated keyword search performed by a context sensitive algorithm that extracts personal information using a result from the keyword search.

19. The method of claim 15 wherein the step of modifying is performed by an algorithm that adds the extracted information to the at least one personal profile.

20. The method of claim 15 wherein the first and the second user have a first and second personal profile, respectively.
